(19) United States
(12) Patent Application Publication
(10) Pub. No.: US 2025/0302060 A1
(43) Pub. Date: Oct. 2, 2025

(54) ALTERNATIVE DAIRY PRODUCTS CONTAINING FUNCTIONAL LIPIDS, AND MANUFACTURING METHODS

(71) Applicants: Yahya BENSOUDA, Rabat (MA); Soumaya EL BOUCHIKHI, Rabat (MA)

(72) Inventors: Yahya BENSOUDA, Rabat (MA); Soumaya EL BOUCHIKHI, Rabat (MA); Azeddine IBRAHIMI, Kenitra (MA)

(73) Assignees: Yahya BENSOUDA, Rabat (MA); Soumaya EL BOUCHIKHI, Rabat (MA)

(21) Appl. No.: 18/864,375

(22) PCT Filed: May 8, 2023
(86) PCT No.: PCT/MA2023/000005

§ 371 Date: Nov. 8, 2024

(30) Foreign Application Priority Data
May 9, 2022 (MA) 56734

(51) Int. Cl. A23C 11/04

(52) U.S. Cl. CPC A23C 11/04

(57) ABSTRACT

A method produces functional dairy-like products by substituting qualitatively and quantitatively natural milk fat with functional fat and formulating an appropriate matrix. The chosen lipids are those with recognized nutritional and functional effects. A dispersion (emulsion or suspension of nano-capsules) based on suitably selected lipids Functional Milk-Like (FML) is produced. The dispersion is transformed into Functional Dairy-Like Products (FDLP): yogurt, dessert cream, hard or spreadable pastes, and drinking yogurt, allowing better acceptability of the targeted lipids. The transformation of FML into FDLP yogurt is carried out by lacto-fermentation. The transformation of FML into FDLP dessert cream involves adding gelling agents. FML is transformed into hard or spreadable FDLP on a more concentrated dispersion by adding gelling and thickening agents (or cheese process). The transformation of FML into FDLP drinking yogurt is carried out by stirring and dilution or attenuation of the gelling effect of lacto-fermentation.

The lean diet (low in lipids) is conventionally the most widespread. That's why there is semi-skimmed or skimmed milk, which reduces or even eliminates the natural 3% milk fat. This practice has been expanded to dairy products in general: low fat or 0% fat yogurt and low-fat dairy desserts.

However, the nutritional quality of unsaturated fatty acids and their role in metabolism are no longer in doubt. Certain oils are thus renowned for their nutritional benefits under certain conditions of use: limit the daily quantity and avoid any degradation by the cooking heat.

Numerous studies have shown the beneficial effects of specific oils, such as cod liver oil (or fish oil in general), Argan oil, Sesame oil, Olive oil, and others. Each oil has a particular advantage for its richness in this or that component (fatty acid, unsaponifiable, etc.).

This is how some studies have shown that integrating one of these oils into a diet is a highly recommended practice. Studies have indeed shown that consuming these oils daily (around 25 ml/day of Argan oil, for example) and under certain conditions (without cooking) has medicinal and well-being properties.

Some of these oils have virtues; however, they have an obstacle to their frequent use: taste acceptability.

To allow easy and appetizing consumption of these oils and/or their fractions and encourage their daily use in food, food supports for these oils and/or their fractions in the form of Functional dairy-like Products (FDLP) and their manufacturing processes are proposed.

### DESCRIPTION

The manufacturing processes relate to dairy-like products in a form similar to yogurt, cream, or a spread, where the milk fat is substituted by functional lipids in general, and in particular, simple oil (only one oil) or compound oil (mixture of oils) added or not oily fractions are described for the first time.

These processes consist of replacing milk with a lipid dispersion whose oily phase composition is chosen carefully, both quantitatively and qualitatively.

Quantitatively, the concentration of the oily phase may vary in the dispersion so that the amount of oil in the portion of the dairy product or dairy-like product corresponds to the quantities usually recommended. For example, these quantities are currently of the order of 25 ml.

In qualitative terms, the oily phase is composed of a single oil chosen from oils with proven nutritional value or a mixture of these oils, fractions of these oils, or even oil(s) enriched with given fractions, such as unsaponifiable in whole or in part.

Thus, the obtained dispersions are transformed into yogurt, dessert cream, or yogurt/spread by adding the necessary ingredients in controlled quantities to respect the final amount of lipids in a reasonable food portion.

For example, suppose the intended portion of the final product is around 125 g, the usual weight of a yogurt. In that case, the oil concentration will be 20% to contain the recommended amount of lipids, currently 25 ml.

Sensory acceptability is worked on two levels: palatability and taste. Palatability is improved by adding consistent ingredients to the matrix, and taste is improved by adding flavors, sweeteners, and/or condiments. Acceptability optimization is conducted using both descriptive analysis and sensory evaluation.

The primary embodiments of the invention comprise a process for manufacturing a product similar to yogurt, where functional lipids substitute milk fat. The method includes a preliminary dispersion step to constitute a phase equivalent to milk in the yogurt manufacturing process. It involves gelling by lacto-fermentation of dispersion based on carefully selected simple or compound lipids. The dispersion can be fermented by adding the necessary ingredients for lacto-fermentation. The lipid concentration in the final yogurt mixture is such that the food portion of the finished product provides at least the currently recommended quantity of lipids: 25 ml/day in the case of Argan oil. This portion can be provided entirely or by adding equivalent products less rich in lipids.

Embodiments of the invention further comprise a method for manufacturing a lipid-fortified dessert cream, which contains the step of dispersion associated with thickening with a food gelling agent such as gelatin, pectin, or equivalent. The lipid concentration in the final mixture of the dessert cream is such that the food portion of the finished product provides the currently recommended amount of lipids: 25 ml/day. This portion can also be provided entirely or by adding equivalent products that are less rich in lipids.

Embodiments of the invention further comprise a yogurt/spread product where the milk fat is substituted by functional lipids between 20 and 40% or more lipids. The spread product can be flavored and packaged in various forms, including a pot or tub. The lipid concentration in the final mixture of the yogurt spread is such that the food portion of the finished product provides the currently recommended amount of lipids: i.e., 25 ml/day. This portion can also be provided entirely or by adding equivalent products lower in lipids.

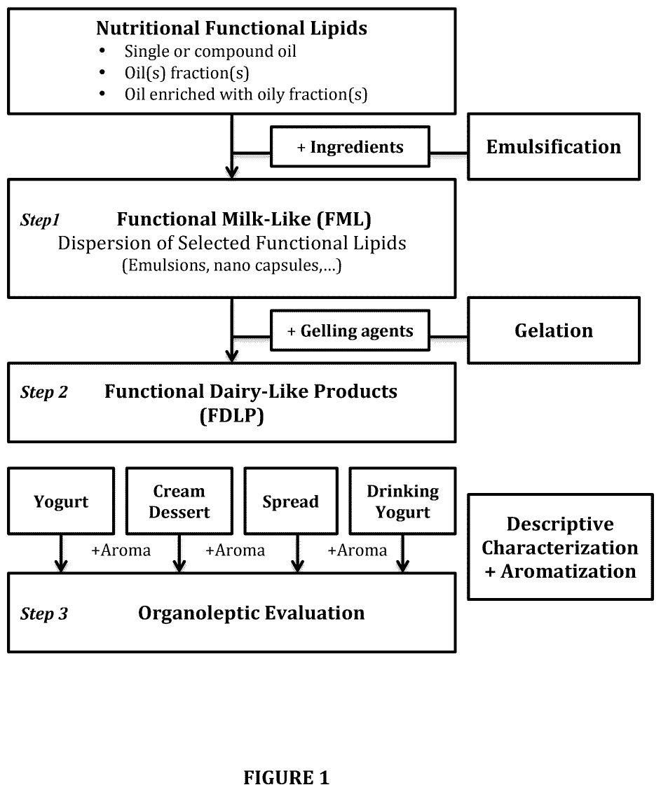

FIG. 1 is a flow chart showing selected steps in a process for manufacturing a dairy-like product in which milk fat is substituted with functional lipids, according to the embodiment of the invention.

### DETAILED DESCRIPTION

The field of invention is functional foods. This invention relates particularly to a manufacturing process for a dairy-like product where functional lipids with health benefits substitute milk fat.

Nutritional science has evolved from a preventive approach to food deficiencies to promoting preventive nutrition. The latter aims to maximize physiological functions to guarantee optimal well-being and health while minimizing the risk of contracting a disease (Weber., 2001; Chanussot F., 2008).

It is now accepted that food must not only provide the nutrients necessary to cover metabolic needs in adequate quantities but also contribute to the improvement of health, hence the concept of functional food.

Thus, a food is said to be functional when it exerts one or more beneficial effects on one or more functions of the body outside of its usual nutritional effects and should, therefore, be part of the daily diet.

Functional foods are becoming increasingly important in scientific research. They preoccupy researchers, healthcare professionals, and agro-food manufacturers on an international scale. This interest is prompted by the increase in many diseases related to lifestyle and food, including cancer.

This invention is viewed from this point of view. Indeed, several oils are renowned for their nutritional interests and physiological roles, particularly Argan oil, Nigella oil, Cod liver oil. Hence, the major interest is in facilitating their daily use in food.

For example, scientific studies have shown that the consumption of 25 ml/d Argan oil has an anti-inflammatory effect, a cholesterol-lowering effect, an antioxidant effect, and an ant-proliferative effect on human cancer lines prostate. It has been proven that its consumption or application improves the elasticity and hydration of the skin of menopausal women after 60 days. However, its consumption remains dependent on local eating habits and its taste acceptability, limiting its consumption worldwide. To improve its acceptability, it has been proposed in this invention to integrate the recommended quantity of Argan oil in a dairy protein matrix stabilized by lacto-fermentation, giving rise to an innovative health product, a yogurt-like

Health-conscious consumers increasingly recognize functional foods' nutritional benefits. Hence, there is interest in substituting undesirable or poorly tolerated milk fat with functional fat that provides health benefits and proposing new dairy products that impact human health with improved sensory characteristics.

The main objective of this invention is, therefore, the formulation of functional dairy products where milk fat is substituted by functional lipids. In particular, the development process(s) of preparing a basic matrix that makes it possible to contain the chosen plant material and guarantee its stability over time.

The said process allows the manufacture of a dairy product where the milk fat is substituted by functional lipids at 20%, which includes several stages:
Step 1: Formulation of lipid dispersion:
   a) Formulation of a dispersing matrix containing milk proteins, sodium caseinate as an emulsifier agent, and modified starch as a stabilizer agent
   b) Integration of the oily phase by homogenization at a speed and for a well-defined duration.
Step 2: Gelation of the lipid dispersion:
   a) by using the glucono-delta-lactone (GDL) or advantageously by the use of lactic ferments of yogurt: the Lactobacillus bulgaris and the Streptococcus thermophilus;
   b) by the use of natural gelling agents like gomme arabic, pectin, and many others;
Step 3: Sensory evaluation of the product where the milk fat is substituted by functional lipids at 20% according to a specific protocol (NF ISO 13299):
   a) Descriptive characterization: appearance, taste, texture, and mouthfeel of the tested formulated products.
   b) Aromatization of the finished product and optimization of the formulation by adjusting concentrations and the manufacturing process.

FIG. 1 above shows the process for making dairy products where the milk fat is substituted by functional lipids. This process begins by providing reconstituted milk, a lipid dispersion used as a starting mixture.
Reconstituted milk or starting mixture may contain skimmed milk proteins, sodium caseinate, starch, chosen fat, and other components deemed useful for formulation.
The desired fat percentage in the final product controls the amount of fat introduced into the mixture.

The ingredients mixture of skimmed milk proteins, sodium caseinate, starch, and chosen fat can form reconstituted milk or lipid dispersion to which yogurt crops can be added.
Yogurt crops can include Streptococcus Thermophilus, Lactobacillus bulgaris, and bifidobacteria, among others.
The yogurt mixture, with the culture, can then be fermented at 42 C for a defined time.
The concentrations of the added sodium caseinate and starch can vary depending on the quantity of the chosen lipid material and homogenization conditions.
The fermented lipid dispersion should not show creaming or syneresis.

The lipid dispersion can form a product or products where milk fat is substituted by functional lipids. The quality and nature of the final product depend on several factors, namely, the protein concentration, particularly sodium caseinate, the starch concentration, the fraction of oil used, and the gelling process.
The product syneresis can be reduced to an optimum level if a mixed sodium caseinate-starch system is used
The product's stability can depend on the sodium caseinate/oil ratio, the starch/sodium caseinate ratio, and the speed and duration of homogenization.
Gelling can be achieved by lactic acid bacteria, biological acidification (yogurt and spread), or gelling agents (dessert cream).
The sensory quality of the finished functional product depends on the concentrations of sodium caseinate and oil used, more precisely, on the mouthfeel thickness and the oily aftertaste.

Furthermore, according to the present invention, the fatty substance is integrated into an aqueous phase in the process, which limits its contact with the oxygen in the air and, therefore, the oxidation phenomenon.

The method for manufacturing a dairy product where functional lipids substitute the milk fat according to the invention has the following advantages in particular:
The method according to the invention is, in fact, particularly interesting since it makes it possible to promote certain local products and improve the quality of the diet;
It makes it possible to obtain a dairy-like product where functional lipids with health benefits substitute milk fat. Indeed, according to the invention, the method makes it possible to substitute milk fat, which is particularly interesting. On the one hand, it limits animal fat intake, which is predominant in milk and can be poorly tolerated by individuals with cardiovascular and other diseases. On the other hand, it helps facilitate the recommended intakes for these functional lipids. At the same time, the method according to the invention also makes it possible to avoid the use of food additives;
It enables us to create an innovative dairy product with satisfactory physical and functional properties and organoleptic qualities.
It allows us to obtain a dairy product that is relatively stable over time;
It allows us to obtain a functional dairy product.

Clear definitions are provided to enhance understanding of the invention. Unless indicated otherwise, all technical terms used in this application should be interpreted according to their standard meanings.

In the context of this invention, the term “matrix” refers to the dispersing phase of the selected oily phase, which varies in composition depending on the desired final product, such as yogurt, dessert cream, or spread.

In the context of this invention, the term “reconstituted milk” refers to the lipid dispersion obtained by integrating the oily phase into the chosen basic matrix.

In the context of this invention, the term “Functional oil” refers to any fat with functional properties for the body, such as Argan oil, Cod liver oil, and others.

The Lipid dispersion can be prepared by homogenization with an ultraturax or through pressure homogenization, as in the dairy industry.

In step 1 a) of matrix formulation, milk proteins, lactose, sodium caseinate, and starch are dissolved in distilled water under magnetic stirring, heat-treated to allow the starch to gel at 70 C, and pasteurized at 85° C. for 15 min. This has the advantage of pasteurizing the matrix while optimizing the production of a product with satisfactory physical, functional, and organoleptic properties.

Step 1 b) of homogenization is carried out at a temperature between 45° C. and 50° C. and at a stirring speed of approximately 10,000 rpm for approximately 15 min. The dairy product obtained has the characteristics of a smooth and creamy dairy cream.

Step 2 of gelling helps stabilize the lipid dispersion over time and can be obtained in several ways:
a) By acidification using either the lactic ferments of yogurt or glucono-delta-lactone (GDL), knowing that the mode of acidification by glucono-delta-lactone is kinetically the closest to that of bacteria;
b) By natural gelling agents such as gum arabic, pectin, etc.

The dairy product obtained should be stored preferably between 4 C and 8 C.

In step 3, a) Descriptive sensory analysis of formulated products (yogurts) was conducted using a trained sensory food panel. Quantitative descriptive profiles were established following a specific protocol (NF ISO 13299). The final list of attributes was as follows: 5 visual attributes, 3 texture attributes, 3 mouthfeel attributes, and 3 taste attributes. Reference standards for acidity and sweetness were developed through a consensus process using (citric acid and sucrose as standard types).

In step 3 b) of the aromatization, 15 expert panelists first evaluated the basic formulated product (P1) (30 g of product per cup) before proceeding to the evaluation of the two flavored products, one with orange blossom (P1FO) and the other with almond (PA1). A new attribute was added, “the oily aftertaste attribute.” As a result, the concentrations of sodium caseinate and Argan oil, as independent variables, affect the sensory responses, such as the textural attributes and the oily aftertaste of the formulated product.

The conditions applied to optimize the production of yogurt-like with Argan oil, were reducing the concentration of sodium caseinates and the aromatization. Although these results are helpful in optimizing the formulations and will produce products optimized from a sensory point of view, further studies with different amounts of Argan oil and a hedonic evaluation are also necessary to develop a product with a high potential for success in mass marketing. Variations in texture and taste perception are not only due to physicochemical interactions between food components but also depend on interactions between sensory modalities. Therefore, an approach linking physicochemical interactions and sensory analysis is essential to produce dairy products with acceptable sensory properties.

The invention also relates to a composition comprising functional food according to the invention; the said composition is selected from the food composition group.

In the context of this invention, the term “food composition” refers to any type of composition suitable for human consumption. Food compositions include dietary compositions (such as Dietary Foods Intended for Special Medical Purposes, an example of products for fragile seniors), functional foods or “health foods,” and food supplements (compositions to satisfy metabolic needs, maintain health, prevent pathologies and aging).

Advantageously, the food compositions according to the invention may be compositions that simultaneously meet the following criteria:
Naturalness: compositions from organic farming without chemical additives;
Pleasure: compositions with highly appreciated organoleptic qualities: creamy compositions, smooth in the mouth;
Health: nutritionally balanced compositions (0% milk fat), compositions to satisfy metabolic needs, compositions to maintain health, compositions to prevent pathologies and aging.

The food compositions according to the invention may, in particular, take any form of food and may, in particular, be chosen from milk, fermented dairy products such as yogurts, fresh cheeses, dairy desserts, spreadable cheese specialties, drinks, ice creams, and infant formulas.

According to the invention, food compositions may comprise any functional oily phase having beneficial effects on health.

According to the invention, the food compositions may comprise between 0.1 and 99% dairy products, depending on the desired effect.

According to the invention, food compositions may further comprise other bioactive ingredients such as antioxidants (vitamins, polyphenols, coenzyme Q10), prebiotics, probiotics, omega-3 fatty acids, collagen, or collagen hydrolysates.

According to the invention, dairy products can be included in compositions to obtain a supply of proteins, calcium, unsaturated fatty acids, and probiotics, particularly in humans.

The present invention also relates to the non-therapeutic use of a functional dairy product or a composition developed according to the invention. The said composition is a food composition intended to prevent specific diseases. According to the invention, the product has the advantage of being compatible with a dietary regime and compensating for possible deficiencies in such a diet, particularly in calcium, proteins, fatty acids, and others.

As previously indicated, the nutritional properties of the functional dairy product, according to the invention, are defined, in particular, at the level of integrated lipids, milk proteins, and probiotics.

Many scientific studies have shown the nutritional interest of unsaturated fatty acids and other oils, including argan oil. Indeed, Argan oil is considered one of the most important seasoning oils, and it offers health benefits beyond its essential nutritional functions. This oil represents a rich source of linoleic and oleic acids, respectively 37% and 45%, in addition to other components (tocopherols, polyphenols, sterols, carotenoids, xanthophylls, and squalene). The unsaponifiable fraction is abundant in these components and has a powerful antioxidant effect, as proven by low-density lipoproteins (LDL) isolated from human plasma. Consumption of edible Argan oil has been shown to positively affect the prevention of certain diseases, such as hypercholesterolemia, cardiovascular diseases, and diabetes, which are known to have a high impact on human health. In addition, it has an improving effect on skin elasticity and hydration in postmenopausal women. All these beneficial effects required a minimum daily amount of 20 g of Argan oil. However, its taste acceptability remains an essential factor limiting its worldwide consumption.

Many scientific studies have shown that milk proteins have excellent nutritional qualities (Léonil et al. 2001, Milk, nutrition and Health, Technique and Documentation editions). They also have specific characteristics whose therapeutic virtues are now beginning to be well known. Examples of milk proteins that exhibit interesting biological activities include immunoglobulins, alpha-lactalbumin, lactoferrin, and lysozymes. Some drugs are being developed from proteins extracted from cow's milk. These drugs are intended, in particular, to treat psoriasis and inflammatory bowel diseases as an alternative to the antibiotics traditionally used (Université de Laval, Quebec). In addition, in an acidic environment, milk proteins casein and whey, due to their coagulation and water-binding capacity, act on the texture, particularly on viscosity, consistency, elasticity, and firmness. Also, many scientific studies have shown that milk proteins, particularly caseins, have properties of water absorption, solubility, gelling, emulsification, and foaming even after having undergone chemical, physical, or even enzymatic treatments (Cheftel et al., 1982).

Fermented food products have a high nutritional value and a beneficial effect on the host's intestinal microbiota due to their probiotic bacteria, which positively impact human health. Among the beneficial health effects of fermented dairy products are reduced risk of cardiovascular diseases, type 2diabetes, and overall mortality, and improved glucose metabolism in addition to other interests, such as generating bioactive peptides by the proteolytic activity of lactic acid bacteria. It also synthesizes some B vitamins, including folate B9, riboflavin B2, B12, and vitamin K2 (menaquinones).

The addition of starch improves the stability of the resulting dairy product. It also increases the value of the rheological and physical properties of fermented gels by improving consistency, increasing viscosity, and reducing syneresis, which contributes to the formation of more stable dispersed acidified milk gel systems.

The present invention also relates to the use of a functional dairy product according to the invention for the preparation of a food composition intended to act as an agent for the prevention of cardiovascular diseases, hypercholesterolemia, diabetes, aging, and many other diseases.

### Example of a Method for Obtaining a Fermented Dairy Product According to the Invention

1—Formulation of a food composition comprising a fermented dairy product according to the invention.

### Preparation of the Matrix:

3.5% skimmed milk protein
5% lactose
1.5% starch
1-2% sodium caseinates
Water q.s.p 100g

The mixture is heated under stirring and pasteurized at 85° C. for about 15 minutes.

The homogenization conditions of the matrix and the oily phase are as follows:
The matrix and oily phase temperature during homogenization: around 45° to 50° C.
The homogenization speed: around 10,000 r/min
The homogenization time: around 15 min

The dispersion is cooled to 42° C. and then inoculated with lactic acid bacteria: L. delbrueckii subsp and S. thermophilus.

The mixture is incubated at 42° C. until it reaches a final pH of approximately 4.5 (4 h-4 h30).

At the end of fermentation, the final product is firm, smooth, and homogeneous. It is then stored between 4° C. and 8° C.

Two results of sensory analysis of food compositions comprising a fermented dairy product according to the invention:

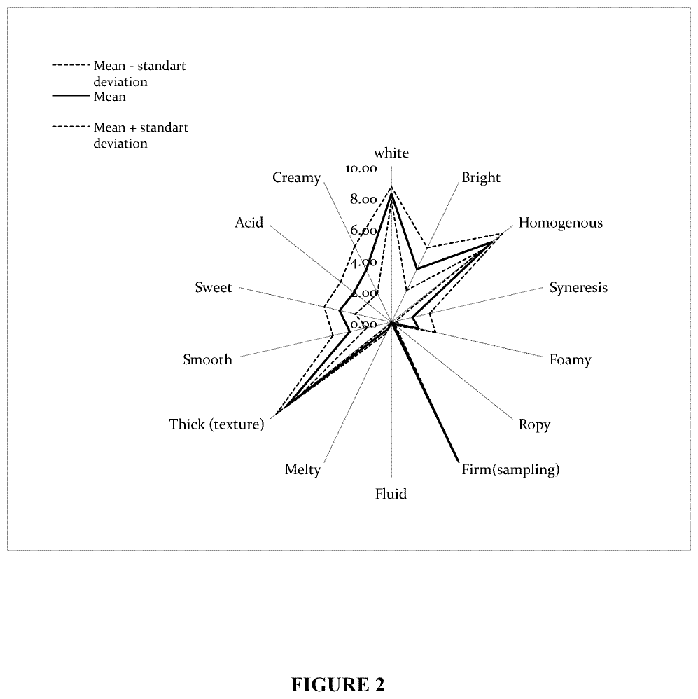

The quantitative descriptive profile of the formulated product nature P1 (FIG. 2):
The product appears white, not bright, and homogeneous with no phase separation or foam.
When scooped with a spoon, it has a firm texture and is not fluid or ropy.
The mouth's texture is very firm, not melty, and not smooth.
Regarding taste, the panelists described it as slightly sweet, with a hint of acidity and creaminess.

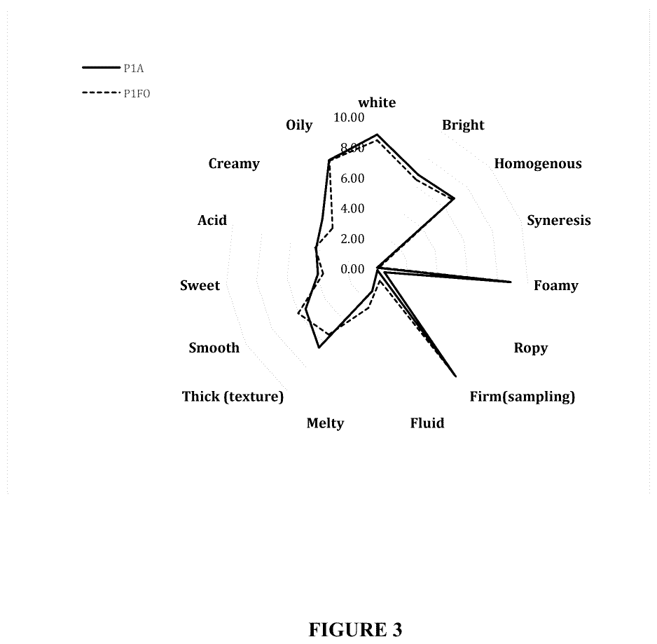

As an example, the following are the quantitative descriptive profiles of the P1A and P1FO orange blossom aromatized products (FIG. 3):
Product appears white, bright, and homogeneous, with no phase separation and foamy on the surface;
When scooped with a spoon, it is firm, is not fluid or ropy;
The mouth's texture is firm, not melty and smooth;
Regarding taste, the panelists described it as low in sweetness, with a hint of acidity and creaminess.

1. Process for preparing dairy-like products, wherein milk fat is substituted with lipids that have beneficial health effects, comprising the following steps:
1-a) formulation and preparation of a basic matrix capable of containing the oily phase in its qualitative and quantitative variations and heat treatment at a temperature between 60 and 95° C. for a duration between 1 and 30 minutes;
1-b) homogenization of said the heat-treated matrix obtained in step 1-a) with a lipid phase having beneficial health effects under a temperature between 25° C. and 70° C.;
2—gelation of the lipid dispersion obtained in step 1-b) by acidification at a pH of about 4.5 using lactic acid bacteria (probiotics) or glucono-delta-lactone (GDL) or a gelling agent;
3—sensory evaluation of the gelled lipid dispersion or the dairy-like products.

2. The process according to claim 1, wherein the lipids with beneficial health effects have scientifically proven physiological and functional properties at recommended amounts, presenting among other things antioxidant, anti-inflammatory or cholesterol-lowering effects, and prevention of certain diseases such as cardiovascular disease, hypercholesterolemia, or diabetes, the lipids with beneficial effects being chosen from a single or compound oil (mixture of oils or oil+extract(s) of oil) selected from the group comprising Argan, Cod liver, Walnuts, Sunflower, Sesame, Corn oil at 20-30 ml/d, Nigella oil 5-10 ml/d, Prickly pear oil 0.1-0.5 ml/d, Borage oil 2-10 ml/d and Evening Primrose oil 1-5 ml/d.

3. Process-The process according to claim 1, wherein the milk fat is substituted at 20% with lipids having health benefits, and where step 1a) the formulation and preparation of the dispersing basic matrix includes milk proteins, sodium caseinate as an emulsifier, and modified starch as a stabilizer.

4. The process according to claim 1, wherein step 1-a) of the basic matrix formulation is carried out at a concentration of milk proteins and derivatives (such as sodium caseinate, whey or micellar casein) between 1 and 10% and a starch concentration between 0.1% and 5%.

5. The process according to claim 1, wherein the basic matrix homogenization step 1-b) is carried out with a health-enhancing lipid phase at a temperature between 25 and 75° C., with a speed of 1000 to 20000 U/min and for a duration of 5 to 30 min.

6. The process according to claim 1, wherein the gelation step 2 is carried out by chemical acidification via glucono-delta-lactone (GDL) or bacterial (lactic and probiotic ferments) or by the use of common gelling agents selected from the group comprising starch, pectins, alginates, carrageenan, and agar-agar.

7. The process according to claim 1, wherein the process involves the addition of any extra ingredient to the basic matrix, to the health-enhancing lipid dispersion, or the finished product dairy-like product, in which the extra ingredient is selected from the group consisting of a native or modified starch, gum or cellulose, acidity regulator, acid, colorant, flavoring agent, firming agent, food protein, a gelling agent, a stabilizer, a thickener, a salt, a sugar, a sweetener, a vitamin, a mineral or dietary compositions such as dietary foods for particular medical purposes, functional foods and food supplements.

8. A method comprising applying the dairy-like product obtained from the process according to claim 1, for the preparation of a food composition intended (e) to act as a healthy food or functional food capable of having physiological effects on the health of individuals and preventing certain diseases.

9. The method according to claim 8, wherein the food compositions are in the form of dairy foods such as fermented or gelled dairy products selected from the yogurts, fresh cheeses, dairy desserts, cheese spread specialties, drinking yogurts, ice creams, and children's formulas.

10. Food composition wherein the food composition contains between 0.1 and 99% of dairy-like products obtained from the process according to claim 1, where milk fat is substituted by lipids with beneficial effects on health, chosen from a single or compound oil (mixture of oils or oil+extract(s) of oil) selected from the group consisting of Argan, Cod liver, Walnuts, Sunflower, Sesame, Corn oil at 20-30 ml/d, Nigella oil 5-10 ml/d, Prickly pear oil 0.1-0.5 ml/d, Borage oil 2-10 ml/d and Evening Primrose oil 1-5 ml/d.

11. The food composition, according to claim 10, wherein it further comprises bioactive ingredients such as antioxidants selected from the vitamins, polyphenols, and coenzyme Q10; pre-biotics; probiotics; Omega-3 fatty acids; collagen or collagen hydrolysates.

12. The food composition, according to claim 10, wherein the food composition comprises a yogurt/spread product where the milk fat contains between 20 and 40% or more by weight of the said lipids with beneficial health effects

13. The food composition, according to claim 10, wherein the lipid with beneficial health effects is Argan oil 25 ml/day.

14. The food composition, according to claim 13, wherein 125 g of said the food composition provides the amount of Argan oil of 25 ml/day.

15. The food composition, according to claim 10, wherein the food composition is in the form of yogurts, fresh cheeses, dairy desserts, cheese spread specialties, drinking yogurt, ice cream, and infant formulas.
